(19) United States
(12) Patent Application Publication
(10) Pub. No.: US 2012/0250173 A1
(43) Pub. Date: Oct. 4, 2012

(54) ELECTRON BEAM WRITING METHOD, ELECTRON BEAM WRITING SYSTEM, UNEVEN PATTERN CARRYING SUBSTRATE MANUFACTURING METHOD AND MAGNETIC DISK MEDIUM MANUFACTURING METHOD

(75) Inventor: Ikuo TAKANO, Minamiashigara-shi (JP)

(73) Assignee: FUJIFILM CORPORATION, Tokyo (JP)

(21) Appl. No.: 13/436,076

(22) Filed: Mar. 30, 2012

(30) Foreign Application Priority Data
Mar. 31, 2011 (JP) 2011-080181

(51) Int. Cl. G11B 5/86; G11B 20/10; G11B 11/08

(52) U.S. Cl. 360/17; 369/126; 369/47.49; 369/84; G9B/11.007; G9B/20.009; G9B/5.308

(57) ABSTRACT

An electron beam writing method for writing a fine pattern that includes servo patterns and groove patterns, the method including the step of adjusting an exposure amount of the resist by changing, when controlling application timing of the electron beam by an ON/OFF signal to a blanking unit that blocks the electron beam, an application duty ratio of the electron beam by the ON/OFF signal with respect to each writing radius position for each pattern based on sensitivity variation data of the resist with respect to post exposure delay for each pattern.

### BACKGROUND OF THE INVENTION

1. Field of the Invention

The present invention relates to an electron beam writing method and an electron beam writing system for writing a desired fine pattern when manufacturing a master substrate for a disk-shaped magnetic recording medium.

The invention also relates to a method, which includes the step of electron beam writing using the electron beam writing method, for manufacturing an uneven pattern carrying substrate having an uneven pattern surface and a method, which includes the step of using the uneven pattern carrying substrate to transfer the uneven pattern thereof, for manufacturing a disk-shaped magnetic medium.

2. Description of the Related Art

Generally, current magnetic disk media include information patterns, such as servo patterns and the like, formed in advance. In view of the demand for higher recording density, a discrete track medium (DTM) in which magnetic interference between adjacent data tracks is reduced by separating the tracks with a groove has been attracting wide attention.

Heretofore, fine patterns, such as servo patterns and the like, have been formed on magnetic media as uneven patterns, magnetic patterns, or the like and in order to produce a magnetic transfer master substrate for manufacturing high density magnetic disk media, an electron beam writing method for patterning a predetermined fine pattern on a substrate coated with a resist is proposed as described, for example, in U.S. Patent Application Publication No. 20040091817 (Patent Document 1).

As for the resist, a chemical amplification resist is used. For example, in the case where a positive chemical amplification resist is used then, after a predetermined pattern is written by an electron beam, a resist pattern according to the written pattern may be obtained by performing what is known as the post exposure bake (PEB) and, thereafter, dissolving the exposed area in a developing solution.

The fine pattern for magnetic disk media has become significantly finer due to increase in recording density, thereby requiring two days to more than one week for writing one fine pattern or even about two weeks for a finer pattern. This causes a problem of resist sensitivity degradation due to time delay from the pattern writing to PEB processing, i.e., due to what is known as the post exposure delay (PED). This is a problem that a greater PED causes a greater sensitivity degradation of the resist with respect to the exposure amount, thereby causing thinning of size (finished size) in the exposed area after development.

The impact of PED becomes greater as the writing time of a fine pattern is extended for one substrate. Further, the impact of sensitivity variations becomes greater as the design line width of the pattern is reduced, and if the PED time becomes large, there may be a case where the pattern cannot be resolved, not just the thinning of line width.

A similar problem is known in a manufacturing process of an optical disk stamper. Consequently, writing methods for preventing the impact of PED are proposed as described, for example, in Japanese Unexamined Patent Publication Nos. 2004-185786 (Patent Document 2) and 2006-010864 (Patent Document 3). More specifically, Patent Document 2 proposes a method that controls the exposure amount by changing the writing linear velocity according to the radial position, while Patent Document 3 proposes a method that controls the exposure amount by changing the amount of beam current according to the radial position.

According to the methods described in Patent Document 2 and Patent Document 3, the exposure amount is controlled to correct size variations due to the impact of PED according to the radial direction position, whereby the uniformity of a pattern width in the exposed area after development may be ensured. Note that Patent Document 2 and Patent Document 3 envisage the manufacture of a stamper for optical disk media. Although, the stamper for optical disk media includes pits and grooves as writing patterns, but the writing widths (sizes) of such patterns are generally the same, so that a favorable uneven pattern may be obtained by controlling the exposure amount according to the radial direction position.

In the mean time, in pattern writing by an electron beam, it is known that a shape actually exposed on the resist differs from a pattern shape written on the substrate by scanning an electron beam according to the density level of a fine pattern due to proximity effect, in which the exposed shape becomes greater than the written shape in a densely arranged portion of the pattern, and that proximity effect correction is required by changing the dose amount (application dose).

The present applicant has proposed a method for controlling the dose amount according to the pattern density level, in which the exposure time of electron beam in a densely arranged portion is set shorter than that in a sparsely arranged portion, in U.S. Patent Application Publication No. 20090242788 (Patent Document 4).

Whereas the pattern width of optical disk media is about 100 nm at a minimum and the time required for writing a pattern on one master substrate is about one day at most, the minimum width of a fine pattern for magnetic disk media currently being tried to achieve is extremely fine, as small as not greater than 50 nm, and it takes two days to more than one week for writing one master pattern or even about two weeks for a finer pattern. The smaller the line width and the longer the time to PEB processing, the greater is the impact of variations in resist sensitivity. Hence, the impact is more serious in pattern writing for magnetic disk media than for optical disk media.

Further, the present inventor has found out a problem which is specific to fine pattern writing for magnetic disk media.

Unlike the pattern for optical disk media, the fine pattern for magnetic disk media includes patterns of different sizes, such as servo patterns and groove patterns.

The present inventor has studied in detail such patterns of a fine pattern after being exposed and developed, and found out that different patterns require different exposure amounts to be corrected even at the same writing radius (i.e., positions of the same PED) (FIG. 4).

The reason may be considered as follows. In a fine pattern which includes patterns of different design sizes, the contrast of exposure intensity distribution is changed in the width direction of writing depending on the scan trajectory of the electron beam writing. That is, for a narrow design size, such as a groove width, the distribution becomes sharp while for a heavy design size, such as a servo bit length, the distribution becomes broad. Therefore, the variation in line width of a narrow design size is small and the sensitivity variation is also small, while the variation in line width of a heavy design size is large and the sensitivity variation is also large even when the same-day PED impact is received. This might cause different amounts of sensitivity variations in patterns of different sizes even when the same-day PED impact is received. That is, the present inventor has found out that, in the case where a fine pattern for disk media includes patterns of different design sizes, such as servo patterns and groove patterns, the use of the methods described in Patent Document 2 and Patent Document 3 to make the exposure amount constant in the same writing radius causes a problem of insufficient exposure amount or excessive exposure amount depending on the pattern type.

As described above, Patent Document 4 proposes a method that changes the exposure amount in the same writing radius according to the pattern density level in order to correct proximity effect. But, neither the degradation in resist sensitivity due to the time to PEB nor exposure amount control between patterns of different sizes in the radial direction is considered.

The present invention has been developed in order to solve the new problem found out by the present inventor, and it is an object of the present invention to provide an electron beam writing method and an electron beam writing system for performing electron beam writing capable of obtaining a resist pattern according to a fine pattern written by correcting size variations due to PED.

It is a further object of the present invention to provide a method for manufacturing an uneven pattern carrying substrate, such as an imprint mold or magnetic transfer master substrate, and to provide a method for manufacturing a magnetic disk medium using the uneven pattern carrying substrate to transfer the uneven pattern or magnetic pattern to the magnetic disk medium.

### SUMMARY OF THE INVENTION

An electron beam writing method of the present invention is a method for writing a fine pattern for a disk-shaped recording medium on a substrate coated with a resist and placed on a rotation stage by applying an electron beam on the substrate while rotating the substrate by rotating the rotation stage and repeatedly changing the writing radius position of the electron beam after each round of writing, the fine pattern including servo patterns and groove patterns extending in a track direction to separate adjacent tracks,

the method including the steps of adjusting an exposure amount of the resist by changing, when controlling application timing of the electron beam by an ON/OFF signal to a blanking unit that blocks the electron beam, an application duty ratio of the electron beam by the ON/OFF signal with respect to each writing radius position for each pattern based on sensitivity variation data of the resist with respect to post exposure delay for each pattern.

The step of adjusting an exposure amount of the resist may include the steps of:

obtaining an exposure amount to be compensated for with respect to the post exposure delay for each pattern from the sensitivity variation data of the resist with respect to post exposure delay for each pattern; and

setting the application duty ratio of the electron beam by obtaining a corrected exposure amount with respect to each writing radius for each pattern from the relationship between the writing radius and the post exposure delay.

The servo pattern may be written by rapidly vibrating the electron beam in circumferential directions or radial directions, as well as deflecting in a direction orthogonal to the rapidly vibrating directions, to individually scan each servo element having a shape of one track width with one bit length and constituting the servo pattern such that the shape is completely exposed by the electron beam, and the groove pattern may be written by dividing the groove pattern into a plurality of groove elements and deflecting the electron beam in a circumferential direction opposite to a direction of the rotation of the rotation stage to individually scan each groove element.

An electron beam writing system of the present invention is a system appropriate for implementing the electron beam writing method of the present invention and includes:

an electron beam writing apparatus having a rotation stage and an electron beam application unit for scanning an electron beam on a substrate coated with a resist and placed on the rotation stage; and

a signal sending apparatus for sending a writing data signal to the electron beam writing apparatus according to a fine pattern for a disk-shaped recording medium to be written on the substrate, the fine pattern including servo patterns and groove patterns extending in a track direction to separate adjacent tracks, wherein:

the writing data signal includes a control signal for controlling application timing of the electron beam by an ON/OFF signal to a blanking unit that blocks the electron beam; and

the signal sending apparatus is an apparatus that sends, as the control signal, a control signal to the electron beam writing apparatus for adjusting an exposure amount of the resist by changing an application duty ratio of the electron beam by the ON/OFF signal with respect to each writing radius position for each pattern based on sensitivity variation data of the resist with respect to post exposure delay for each pattern.

An uneven pattern carrying substrate manufacturing method of the present invention is a method, including the steps of:

writing a fine pattern for a disk-shaped recording medium on a substrate coated with a resist by the electron beam writhing method of the present invention; and

using the substrate on which the fine pattern is written, forming an uneven pattern according to the fine pattern.

Here, the term “uneven pattern carrying substrate” as used herein specifically refers to a substrate having a desired pattern shape on a surface thereof, that is, an imprint mold for transferring the shape of the uneven pattern to a disk-shaped recording medium.

A disk-shaped recording medium manufacturing method of the present invention is a method, including the step of transferring an uneven pattern, using an imprint mold as the uneven pattern carrying substrate manufactured by the method of the present invention, according to the uneven pattern formed on a surface of the imprint mold.

According to the electron beam writing method and electron beam writing system of the present invention, in writing a fine pattern, which includes servo patterns and groove patterns, for disk-shaped recording medium, an exposure amount of the resist is adjusted by changing, when application timing of the electron beam is controlled by an ON/OFF signal to a blanking unit that blocks the electron beam, an application duty ratio of the electron beam by the ON/OFF signal with respect to each writing radius position for each pattern based on sensitivity variation data of the resist with respect to post exposure delay for each pattern. This allows the exposure amount of the resist to be corrected with an appropriate correction amount for each pattern so that the resist sensitivity degradation due to PED may be appropriately compensated. Consequently, occurrence of resist residue or bridge formation is prevented after development and a sharp pattern with a line width close to the design size (line width) may be obtained.

According to the uneven pattern carrying substrate manufacturing method of the present invention, an uneven pattern carrying substrate is manufactured by the steps of writing a fine pattern for a disk-shaped recording medium on a substrate coated with a resist by the electron beam writing method described above and forming an uneven pattern according to the fine pattern. This may yield a substrate having a high precision uneven pattern shape on a surface thereof.

### BRIEF DESCRIPTION OF THE DRAWINGS

FIG. 1 is a plan view, illustrating an example fine pattern to be written on a substrate by the electron beam writing method of the present invention.

FIG. 2 is a partial enlarged view of the fine pattern shown in FIG. 1.

FIG. 3 illustrates a writing method “A” and various signals “B” to “G” used in the writing method.

FIG. 4 illustrates resist sensitivity variation with respect to PED.

FIG. 5 illustrates corrected exposure amount with respect to PED.

FIG. 6 illustrates PED with respect to writing radius.

FIG. 7 illustrates PED-compensated exposure amount.

FIG. 8 shows duty ratio with respect to PED-compensated exposure amount.

FIG. 9 is a block diagram of an electron beam writing system, according to an embodiment, for implementing the electron beam writing method of the present invention, illustrating a schematic configuration thereof.

FIG. 10 is a schematic cross-sectional view illustrating a transfer-forming process of a fine pattern using an imprint mold having the fine pattern written by the electron beam writing method.

FIG. 11 illustrates line width with respect to writing radius in a servo section of an Example and a Comparative Example.

FIG. 12 illustrates line width with respect to writing radius in a groove section of the Example and Comparative example.

FIG. 13A is a SEM image of the servo section of the Comparative Example.

FIG. 13B is a SEM image of the servo section of the Example.

FIG. 14A is a SEM image of the groove section of the Comparative Example.

FIG. 14B is a SEM image of the groove section of the Example.

### DESCRIPTION OF THE PREFERRED EMBODIMENTS

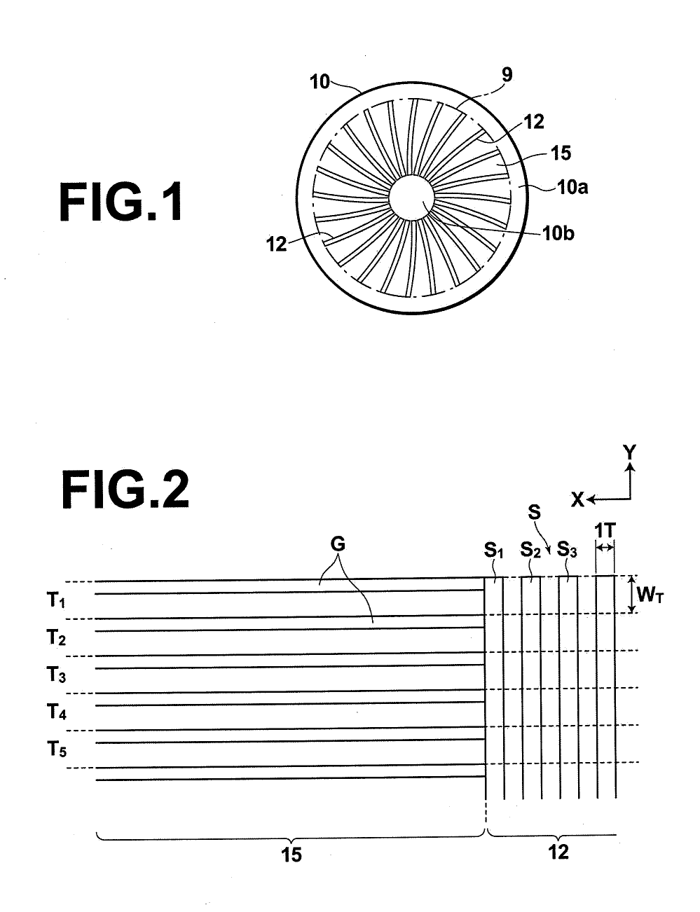

Hereinafter, embodiments of the present invention will be described in detail with reference to the accompanying drawings. FIG. 1 is an overall plan view of a fine pattern to be written on a substrate by the electron beam writing method of the present invention for a disk-shaped recording medium, more specifically for a magnetic disk medium here. FIG. 2 is a partially enlarged view of the fine pattern shown in FIG. 1.

As illustrated in FIG. 1, the fine pattern for a magnetic disk medium is a pattern for a discrete track medium and includes servo areas 12 and data areas 15 disposed alternately in a circumferential direction, in which a servo pattern S is formed in each servo area 12 and a groove pattern G is formed in each data area 15. The fine pattern is formed on an annular region of disk-shaped substrate 10 excluding an outermost circumferential region and an innermost circumferential region.

Servo patterns S are formed in elongated servo areas 12 substantially radially extending from the center to each sector on concentric tracks of substrate 10 at a regular interval. Servo patters S include, for example, patters corresponding to preamble, address, and burst signals, and FIG. 2, which is a partial enlarged view of the fine pattern in FIG. 1, shows a pattern corresponding to the preamble part. The servo pattern S includes multiple servo elements S₁, S₂, S₃, - - - , each having the shape of a substantially parallelogram with one track width and one bit length (1 T). Each element corresponds to one unit of writing.

In the mean time, the groove patterns G are formed concentrically so as to extend in a track direction and separate adjacent tracks.

In the final discrete track medium, areas in which groove patterns G and servo patterns S are written become concave portions and the other portions become planar (land) portions of a magnetic layer. Note that the concave portions may be filled with a non-magnetic material.

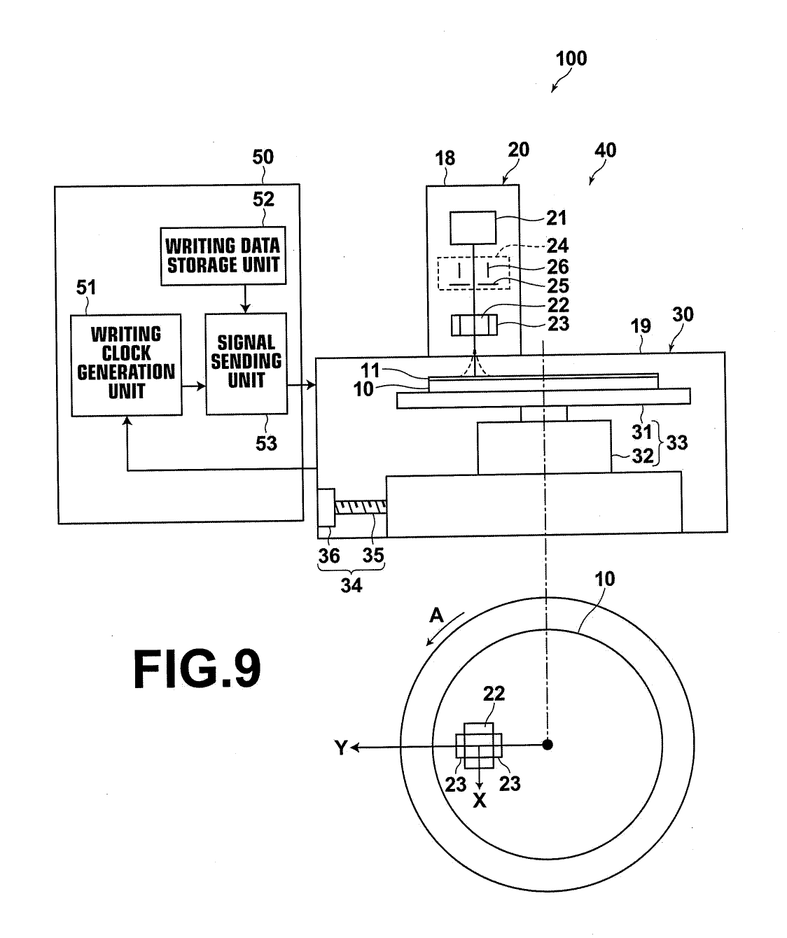

When writing servo patterns S and groove patterns G, substrate 10 coated with resist 11 is placed on rotation stage 31 (FIG. 9), and while substrate 10 is rotated, the substrate is scanned with the electron beam EB to expose resist 11 one track at a time from the inner circumferential side to the outer circumferential side or vice versa. Substrate 10 is made of, for example, silicon, glass, or quartz.

As described above, it takes a long time to write a fine pattern over the entire surface, the time to PEB processing (PED) differs greatly between the writing start position and writing end position. Here, the longer the time to PEB processing, the greater the sensitivity degradation with respect to the exposure amount, thereby causing a problem that the width after development becomes narrower in comparison with the case where the PEB processing is performed immediately after the exposure.

In the electron beam writing method of the present invention, pattern writing is performed based on a control signal incorporating exposure correction for compensating for the size variation. Hereinafter, the electron beam writing method will be described in detail.

In a typical magnetic disk medium, signal writing and reading is performed in a constant angular velocity (CAV) mode. Therefore, in the pattern of magnetic disk medium, the element length in the circumferential direction (physical bit length) becomes large as the circumferential length becomes large from the inner circumferential side to the outer circumference side, although each track width (track pitch) of concentric tracks is constant, so that signals read out from servo elements become identical over the entire disk when the pattern is rotary driven as a final magnetic disk medium.

In the mean time, during the writing such a fine pattern for magnetic disk medium, when radial position is changed, i.e., the track is changed for writing within the writing area of substrate 10, the rotation speed of rotation stage 31 is controlled so as to be slow when an outer track is to be written and fast when an inner track is to be written so that the same linear velocity is obtained in the entire writing area of substrate 10, including the outer circumference side and inner circumference side.

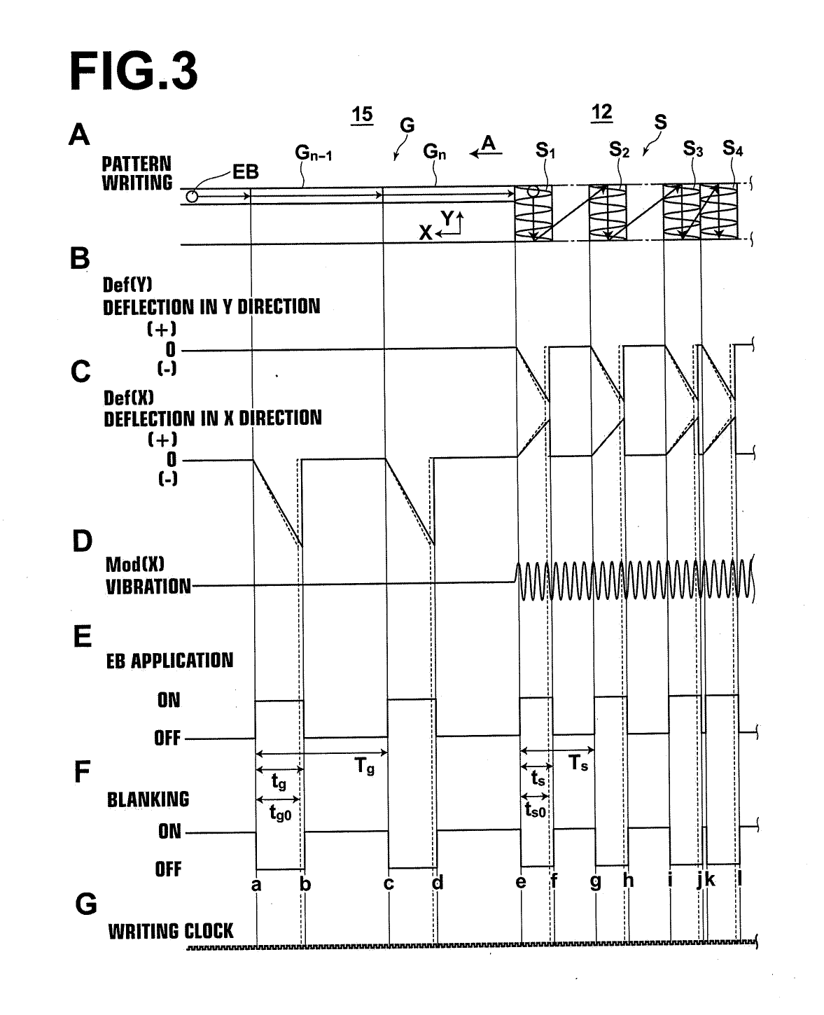

FIG. 3 is a timing chart for implementing the electron beam writing method of the present invention. In FIG. 3, “A” illustrates a writing operation of the electron beam EB in radial direction Y and circumferential direction X. “B” illustrates deflection signal Def (Y) in radial direction Y, “C” illustrates deflection signal Def (X) in circumferential direction X, “D” illustrates vibration signal Mod (X) in circumferential directions X, “E” illustrates ON/OFF operation for application of electron beam EB, “F” illustrates ON/OFF signal to banking unit, and “G” illustrates writing clock signal. The horizontal axis in “A” of FIG. 3 represents the phase of substrate 10, and those in “B” to “G” of FIG. 3 represent time.

In the present embodiment, it is assumed that groove patterns G and servo patterns S for one track are written at a time during one revolution of substrate 10. Each groove pattern G is written by writing groove elements Gₙ divided in a circumferential direction at a constant time interval while rotating substrate 10 (rotation stage 31). Each of the groove elements Gₙ is written by deflecting the electron beam in a circumferential direction opposite to the rotational direction “A”. The groove elements Gₙ are written by so called “single line writing” without rapidly vibrating the electron beam.

In the mean time, each servo pattern S is written by scanning a small diameter electron beam EB over the servo elements S₁, S₂, - - - , each extending the track width, such that the shape of each servo element is completely exposed by the electron beam EB while rotating substrate 10. The scanning of the electron beam EB for completely exposing the element shape is achieved by X-Y deflecting the electron beam EB having a small beam diameter in radial direction Y and circumferential direction X and rapidly vibrating the beam back-and-forth in circumferential directions X, while application of the electron beam EB is ON/OFF controlled by the operation of blanking unit 24, to be described later.

As described above, ON/OFF control of the application of the electron beam EB is implemented by ON/OFF controlling the blanking unit. Direct output ON/OFF control of the electron beam itself from an electron gun, to be described later, is undesirable in view of the stability of the electron beam and, therefore, ON/OFF control of the application of the electron beam EB is generally implemented by ON/OFF controlling the blanking unit that blocks the electron beam. In the following, application state of the electron beam corresponds to OFF state of the blanking unit and non-application state of the electron beam corresponds to ON state of the blanking unit.

The groove elements Gₙ₋₁ and Gₙ are basically written by applying the electron beam at points “a” and “c” respectively to start writing and the electron beam EB at the writing start positions is deflected in a circumferential direction (−X) opposite to the rotational direction “A” by the deflection signal Def (X) shown in “C” of FIG. 3. Then, at points “b” and “d”, the application of the electron beam EB is terminated by turning the blanking signal BLK to ON to complete the writing of each of the groove elements. After writing of each groove element, the deflection in the circumferential direction X is reset to the fiducial position.

The elements S₁ to S₄ are basically written by applying the electron beam at points “e”, “g”, “i”, and “k” respectively to start writing and, while being vibrated back-and-forth in circumferential directions X by the vibration signal Mod(X) in “D” of FIG. 3, the electron beam EB at the writing start positions is deflected and shifted in a radial direction (−Y) by the deflection signal Def(Y) in “B” of FIG. 3 and at the same time deflected and shifted in a direction (X) corresponding to the rotational direction “A” by the deflection signal Def(X) in “C” of FIG. 3 in order to compensate for the displacement of the electron beam application position due to the rotation of substrate 10, whereby the electron beam EB is scanned such that the rectangular servo elements S₁ to S₄ are completely exposed by the electron beam EB. Then, at points “f”, “h”, “j”, and “l”, the application of the electron beam EB is terminated by turning the blanking signal BLK to ON to complete the writing of each of the servo elements S₁ to S₄. After writing of each servo element, the deflection in the radial direction Y and circumferential direction X are reset to the fiducial position. Note that the length of each of the servo elements S₁ to S₄ in the circumferential direction X is defined by the amplitude of the back-and-forth vibration of the electron beam EB in the circumferential directions.

After the writing for one round of one track is completed, writing for the next track is performed in the same manner as described above, whereby a desired fine pattern is written over the entire area of substrate 10. The change of tracks (shift in a radial direction) for writing may be implemented by deflecting the electron beam EB in the radial direction Y or by linearly moving rotation stage 31 in the radial direction Y. The linear movement of the rotation stage may be performed for the writing of every plurality of tracks according to the deflectable range of the electron beam EB in radial direction Y or for the writing of each track. Movement in the radial direction by the deflection unit is more efficient and it is, therefore, preferable that the track change is implemented by the deflection within the range in which movement in the radial direction is possible by the deflection unit, and after a plurality of tracks is written, the deflection of the electron beam in the radial direction by the deflection unit may be released and the rotation stage is moved in the radial direction by, for example, a plurality of tracks using linear moving unit 34.

In implementing the track change in the writing area of substrate 10, it is preferable that rotational speed of the rotation stage is controlled so as to be increased for inner track writing and decreased for outer track writing in order to maintain the linear velocity of the rotation stage constant over the entire writing area of substrate 10.

The beam intensity of the electron beam EB is set to a level that allows resist 11 to be sufficiently exposed with a minimum corrected exposure amount. The beam intensity is maintained constant over the entire writing area. The writing width (real exposure width) by the electron beam EB tends to become broader than the beam diameter and amplitude according to the application time and amplitude of the electron beam EB. Thus, in order to write an element having a desired final element width, it is necessary to control the amplitude and deflection speed and perform scanning with a predetermined amount of radiation exposure.

In the present embodiment, in order to compensate for resist sensitivity degradation due to PED, the dose applied to the resist, that is, the exposure amount of the resist is adjusted for each of the groove and servo patterns at each writing radius by changing the duty ratio (t_{g}/T_{g}, tₛ/Tₛ) of the application of the electron beam EB for each pattern by the ON/OFF control signal to blanking unit 24 based on the sensitivity variation data of the resist with respect to post exposure delay for each pattern. The impact of the PED is significant in the circumferential width of the preamble pattern in which servo elements are continuously disposed in the radial direction for the servo pattern and in the radial width (groove width) for the groove pattern extending in the circumferential direction. While the groove width is constant regardless of the radius, the circumferential width of the preamble pattern is different with respect to each radius. Consequently, the variation in the corrected exposure amount is different between the servo pattern and groove pattern at each writing radius position.

The deflection signal Def(Y) in radial direction Y, deflection signal Def(X) in circumferential direction X, vibration signal Mod(X) in circumferential direction X, and ON/OFF signal of the blanking unit are control signals set in advance such that the electron beam is applied to the resist with an application dose (exposure amount) corrected to compensate for the resist sensitivity degradation.

A specific setting of correction control signals will be described by way of example.

It is assumed here that a fine pattern constituted by a servo pattern, which includes a preamble, address, and burst, and a groove pattern is to be written. The recording density is 800 Gbpsi class and writing area is 2.5 inches (about 63.5 mm). The radial dimension (track pitch) of each servo element, which is the unit of writing, is 60 nm and the circumferential dimension (1 T) varies with the radial position, in which it is assumed to be 95 nm at a radial position of 30 mm and 47 nm at a radial position of 15 mm. That is, the size of the servo element, which is the unit of writing, is 60 nm×95 nm at a radial position of 30 mm and 60 nm×47 nm at a radial position of 15 mm. In the mean time, the radial dimension (width) of the groove pattern is constant regardless of the writing radius position and is assumed to be 30 nm.

It is assumed that the electron beam writing is performed using an R-θ electron beam writing apparatus. More specifically, electron beam writing is performed from the outer circumferential side toward the inner circumferential side using an electron beam with an acceleration voltage of 50 kV. The linear velocity is assumed to be constant at 100 mm/s and the time required for perform writing over the entire surface is assumed to be about 6 days. A Si substrate is used as substrate 10 and a positive chemical amplification resist (CAR) is used as resist 11. The prebake (PreB) is performed at 120° C. for 90 seconds and post exposure bake (PEB) is performed at 110° C. for 90 seconds. It is assumed that a 60 second puddle development is performed using a developing solution which includes 2.38% of TMAH (Tetra-methyl-ammonium-hydroxyde).

### (Determination of Correction Condition)

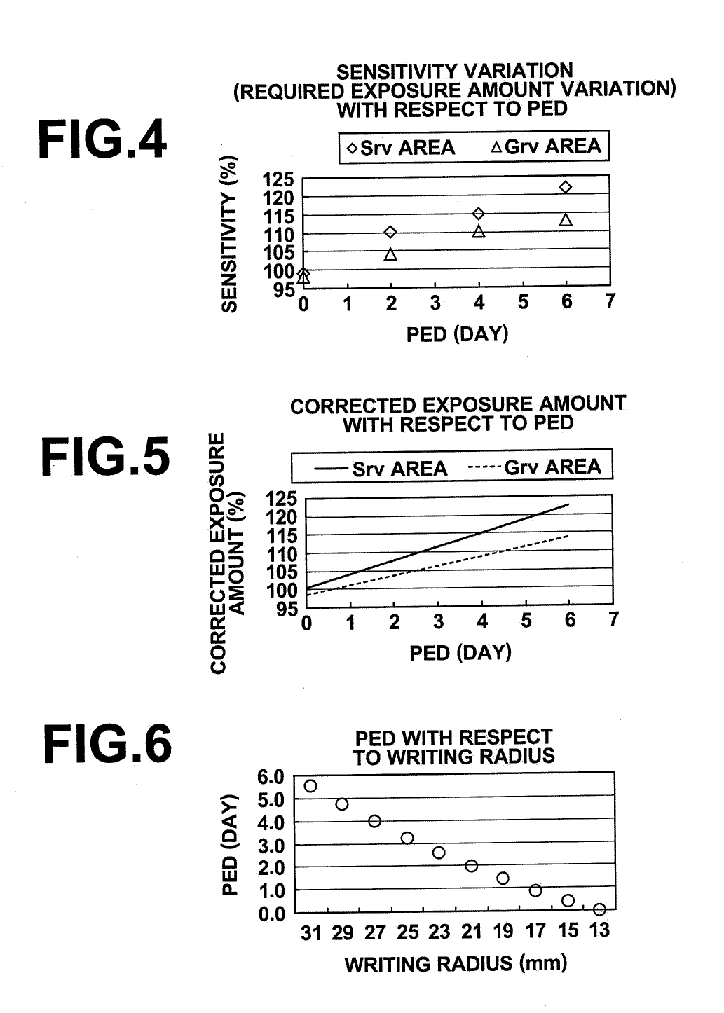

The correction condition is determined in the following manner. First, data of resist sensitivity (required exposure amount) variation with respect to each PED for each of the servo pattern and groove pattern included in a fine pattern are obtained (FIG. 4). The resist sensitivity is generally represented by the exposure amount required for development and an increase in the required resist exposure amount serves as the index of resist sensitivity degradation. With the resist sensitivity (required exposure amount) obtained when PEB processing is performed on the same day as the exposure (PED is 0) being set to 100%, FIG. 4 shows exposure amounts for obtaining the same post development line width as that of the case in which PED is 0 when PEB processing is performed after different PEDs.

As shown in FIG. 4, the servo pattern (Srv area) and groove pattern (Grv area) have different sensitivity variation slopes. At a delay time of 0, the servo area and groove area have different sensitivity values, which might be attributable to the impact of post coat delay (PCD) on the sensitivity variation, but the difference due to the PCD is negligibly small in comparison with the impact of PED. As shown in FIG. 4, the sensitivity variation with respect to the PED time differs largely between the Srv area and Grv area. Therefore, it is clear that the corrected exposure amounts for the respective areas need to be determined according to the sensitivity variations of the respective areas.

From the sensitivity variation data of resist with respect to each PED for each pattern, the corrected exposure amount with respect to PED is calculated (FIG. 5). The required exposure amount increases with an increase in the PED in order to compensate for the sensitivity degradation at the time of development. The corrected exposure amount for the Srv area differs from that of the Grv area.

A PED with respect to each writing position is obtained from the linear velocity of rotation, writing start radius, and writing end radius. FIG. 6 shows the case in which the writing is performed in series from a radius of 31 mm on the outer circumferential side to a radius of 13 mm on the inner circumferential side. When the time delay (PED) to the post exposure bake at the writing end radius of 13 mm is assumed to be zero (0), the post exposure delay time at the writing start radius of 31 mm is about 5.6 days. The PED gradually decreases from the writing start position toward the writing end position. Here, the PED slightly differs from writing position to position in the same radius, but each writing position in the same radius may be presumed to have substantially the same PED.

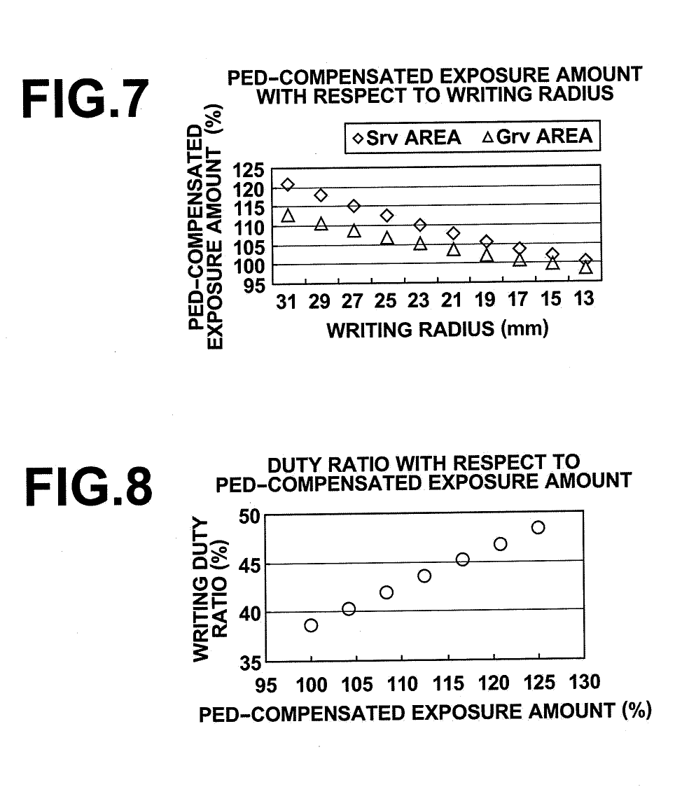

From the relationship of the corrected exposure amount with respect to each PED shown in FIG. 5 and the relationship of PED with respect to each writing radius shown in FIG. 6, a PED-compensated exposure amount at each writing radius is obtained for each pattern as shown in FIG. 7. The writing radius position having a larger PED needs to be exposed with a larger exposure amount. When the exposure amount of each of the Srv and Grv areas is assumed to be 100%, the Srv area requires an increase of 20% and the Gry area requires an increase of 13% in the exposure amounts at the writing start radius (31 mm), as shown in FIG. 7.

Consequently, the application duty ratio of electron beam with respect to the PED-compensated exposure amount (duty ratio) is calculated. FIG. 8 is a graph illustrating the duty ratio with respect to the PED-compensated exposure amount. FIG. 8 shows that the duty ratio is set so as to be 50% at a PED-compensated exposure amount slightly greater than the maximum amount (130% in this case). That is, the duty ratio for the writing with the PED-compensated exposure amount of 100% (PED is 0) is set smaller. The duty ratio for achieving the PED-compensated exposure amount with respect to each writing radius shown in FIG. 8 is set for each pattern. Here, even in the same writing radius, the Srv area and Grv area differ in the corrected exposure amount so that an appropriate duty ratio is set with respect to each writing radius for each pattern.

For the Srv area, for example, the electron beam application time based on the duty ratio may be set by adding or subtracting writing clocks corresponding to the base writing time allocated to write an element of one unit of writing by an integer number of clocks. The application duty ratio of the electron beam is set with respect to each writing radius, and the duty ratio is controlled by an OFF/ON signal to the blanking unit.

As described above, the writing duty ratio is defined by the number of writing clocks. That is, the writing time for each of the serve element and groove element is set by the number of clocks in the writing clock signal in “G” of FIG. 3.

The writing clock signal in “G” of FIG. 3 is a signal generated in a signal sending apparatus, to be described later, based on a constant clock signal (basic clock signal) that does not vary with the situation. The clock width (clock length) of the writing clock signal is changed with a change in the rotation speed of rotation stage 31 such that the number of clocks in one revolution (one round) is constant between inner track writing and outer track writing even when the rotation speed of the rotation stage 31 is changed. That is, the clock width is varied according to the radius “r” with respect to each predetermined number of tracks so as to be narrow in an inner track and wide in an outer track.

Then, the dimensional and temporal widths in circumferential direction (rotational direction A) are defined by the number of clocks of the writing clock signal and fine patterns are basically written with the same number of clocks between an inner track and an outer track. This allows the inner circumferential side and outer circumferential side to have the same number of clocks at the same angle (phase), whereby similar patterns are written easily.

That is, each of the control signals in “B”, “C”, and “F” of FIG. 3 is set such that the length in the circumferential direction X thereof becomes longer by a predetermined magnification for outer track writing in comparison with inner track writing. In addition, the signal in “D” of FIG. 3 is set larger in amplitude for the outer circumferential side than for the inner circumferential side by a magnification corresponding to an increase in the width of the servo element. The base deflection speeds in the circumferential direction X and radial direction Y are slow for writing on the outer circumferential side and fast for writing on the inner circumferential side. In the mean time, the basic clock signal is generated at a constant time interval, and the width of the writing clock signal in “G” of FIG. 3 is adjusted such that each radius has the same number of clocks for one round based on the basic clock signal. That is, the clock width is increased by the same magnification as that of the signals in “B” to “F” in FIG. 3. Then, the ON/OFF timing and shape of each control signal are set by counting the number of clocks of the writing clock signal.

As described above, the clock width of the writing clock signal in “G” of FIG. 3 becomes narrow in an inner track and wide in an outer track, while rotation speed of rotation stage 31 is slow in an outer track and fast in an inner track, both of which are changed simultaneously in synchronization with each other. Even when the writing radius position “r” is slightly changed during the same rotation speed, an element of substantially the same form may be written at the same phase position by the control of the same number of clocks since the number of clocks for one round is the same. Here, the relative movement speed of resist 11 with respect to the electron beam EB differs depending on the radius position, in which it is slightly faster in an outer circumference and the exposure amount per unit area is changed. But, the signal widths of written servo elements are substantially the same as the signal width is dependent on the amplitude of the vibration signal in “D” of FIG. 3. A slight change in the writing track position may be compensated for by the resist sensitivity, signal accuracy, and the like, without changing the rotation speed and clock width of the writing clock signal, and the servo elements may be used as the actually recorded information without any problem. Therefore, it is not necessary to change the rotation speed and clock width of the writing clock signal for each track change and may be changed, for example, every eight tracks, as described above.

Then, as described above, the writing time (electron beam application time) for each element based on the duty ratio for achieving the corrected exposure amount is adjusted by increasing or decreasing an integer number of clocks.

For example, if the base time “t” allocated to the writing of each servo element is 62 clocks (tₛ=62 clocks), the period Tₛ=124 clocks. The duty ratio (tₛ/Ts=62/124) is set to 50% at a corrected exposure amount slightly greater than the maximum corrected amount (130%). At the writing radius of 31 mm, the corrected exposure amount is 121% and the duty ratio is 47%. This yields 124×0 0.47=58.28 clocks. For ease of control, writing time is increased or decreased with an integer number of clocks. Thus, in this case, the writing time may be set to 58 clocks.

When the base writing time allocated to the writing of each groove element is taken as t_{g}, and the period is taken as T_{g}, the number of writing clocks is set so that the duty ratio (t_{g}/T_{g}) becomes about 44% since the corrected exposure amount at the writing radius of 31 mm is 113%. The number of clocks for the t_{g} may be the same or different from that of the servo element. In the present embodiment, they are different.

Each of the periods T_{g} and Tₛ is set to twice the number of clocks of the base writing time. That is, the application duty ratio of the electron beam is a ratio of ON time for element writing to the twice of the base writing time.

FIG. 3 illustrates the timing chart for writing near the writing start radius that requires a maximum corrected exposure amount. The duty ratio of EB application/non-application when the groove element Gₙ is written is t_{g}/T_{g}, while the duty ratio of EB application/non-application when the servo element Sₙ is written is tₛ/Tₛ. EB application time t_{g0} for writing the groove element Gₙ and EB application time tₛ₀ for writing the servo element Sₙ near the writing end radius that requires a minimum corrected exposure amount are adjusted such that each of the duty ratios t_{g0}/T_{g} and tₛ₀/Tₛ becomes 39%.

As the electron beam application time is changed, it is necessary to change each deflection speed in the radial direction (Y direction) and the circumferential direction (X direction) such that the electron beam is deflected by a predetermined amount within the application time.

In this way, the line width variation due to PED may be corrected by the exposure amount control by gradually reducing the writing time from the writing start radius to the writing end radius according to the PED time, whereby a line width as designed may be obtained. Patent Document 2 and Patent Document 3 described under the “Description of the Related Art” may correct the exposure amount with respect to each radial position by changing the linear velocity or amount of beam current according to the radial position. Such conventional methods, however, are unable to change the exposure amount with respect to each of different patterns in the same radius. On the other hand, the method in which the duty ratio is changed, as described above, may easily change the corrected exposure amount for each pattern in the same radius.

An embodiment of the electron beam writing system of the present invention for implementing the electron beam writing method of the present invention will be described with reference to FIG. 9. Electron beam writing system 100 of the present embodiment shown in FIG. 9 includes electron beam writing apparatus 40 and signal sending apparatus 50. Electron beam writing apparatus 40 includes electron beam application unit 20 for applying an electron beam to substrate 10 and mechanical drive unit 30 for rotating and linearly moving substrate 10.

Electron beam application unit 20 includes electron gun 21 that emits an electron beam EB within lens tube 18, deflection unit 22, 23 that deflect the electron beam EB in radial direction Y and circumferential direction X, as well as microscopically vibrating the beam back and forth in circumferential direction X with constant amplitude, and aperture 25 and blanking 26 (deflector) as blanking unit 24 for causing application/non-application of the electron beam EB onto substrate 10. The electron beam EB emitted from electron gun 21 is applied to substrate 10 with resist 11 coated thereon through deflection unit 22, 23, a not shown electromagnetic lens, and the like.

Aperture 25 of blanking unit 24 has a through hole in the center for passing the electron beam EB, and blanking 26 operates according to input of an ON/OFF signal for the application of the electron beam EB, in which it passes the electron beam EB through the through hole of aperture 25 to direct the electron beam EB onto the substrate 10 during ON-signal without deflecting the beam, while it blocks the electron beam EB with aperture 25 by deflecting the beam so as not to pass through the through hole during OFF-signal, so that the electron beam EB is not directed onto the substrate.

That is, the ON/OFF ratio of blanking unit 24 corresponds to the application/non-application ratio of the electron beam EB.

Mechanical drive unit 30 includes rotation stage unit 33 having rotation stage 31 that supports the master substrate and spindle motor 32 inside of housing 19 on which lens tube 18 is disposed, and linear moving unit 34 that linearly moves rotation stage unit 33 in a radial direction of rotation stage 31. Linear moving unit 34 includes rod 35 having accurate threading threadably mounted on a portion of rotation stage unit 33 and pulse motor 36 that rotary drives the rod 35 in forward and reverse directions. Rotation stage unit 33 further includes an encoder, not shown, that outputs an encoder signal according to the rotation angle of rotation stage 31. The encoder includes a rotation plate having multiple radial slits formed therein and attached to the motor shaft of spindle motor 32 and an optical device that optically reads the slits, and sends an encoder signal generated at predetermined rotational phases at an equal interval through the reading of the encoder slits to signal sending apparatus 50.

The drive control of spindle motor 32, i.e., rotational speed control of the rotation stage 31, drive control of pulse motor, i.e., linear movement control by linear moving unit 34, modulation control of the electron beam EB, control of defection unit 22, 23, ON/OFF control of blanking 26 of blanking unit 24, and the like are performed based on the control signals sent from signal sending apparatus 50. Signal sending apparatus 50 stores therein writing data based on a desired disk medium fine pattern (design pattern) and sends various control signals to electron beam writing apparatus 40 based on the writing data signal.

Signal sending apparatus 50 includes writing data storage unit 52, writing clock generation unit 51 for generating writing clocks for taking the timing of writing, and signal sending unit 53, constituted by a control IC (integrated circuit), for generating various control signals and sending them to electron beam writing apparatus 40 as a writing data signal. Signal sending apparatus 50 may be formed of a so-called formatter.

Writing data based on a design pattern to be written are sent from a not shown external design data processing apparatus to signal sending apparatus 50 and stored in writing data storage unit 52 before electron beam writing is started.

Writing clock generation unit 51 includes a reference clock generation unit that generates constant reference clocks and generates a writing clock signal having a clock width according to each radial position based on the reference clocks, as well as an encoder signal and radial position signal from electron beam writing apparatus 40.

In electron beam writing system 100, signal sending apparatus 50 allocates writing data signal constituted by control signals for ON/OFF control of the blanking, X-Y deflection control of the electron beam EB, rotational speed control of rotation stage 31, and the like, to each amplifier and driver. Each data signal is sent at predetermined timing based on the encoder pulse inputted from encoder 37 and writing clocks.

Then, in electron beam writing apparatus 40, drive control of spindle motor 32, i.e., rotational speed control of the rotation stage 31, drive control of pulse motor 36, i.e., linear movement control by linear moving unit 34, modulation control of the electron beam EB, control of defection unit 22, 23, ON/OFF control of blanking 26 of blanking unit 24 (application/non-application control of electron beam), and the like are performed based on the writing data signal sent from signal sending apparatus 50.

The writing data signal is data for writing a magnetic disk fine pattern which includes a plurality of different patters, that is, servo patterns and groove patterns. It is a control signal incorporating a corrected exposure amount for compensating for a size variation due to PED in the electron beam writing method of the present invention described above to change the application duty ratio of the electron beam with respect to each writing radius for each pattern, thereby controlling the exposure amount of the resist.

### <Uneven Pattern Carrying Substrate Manufacturing Method and Magnetic Disk Medium Manufacturing Method>

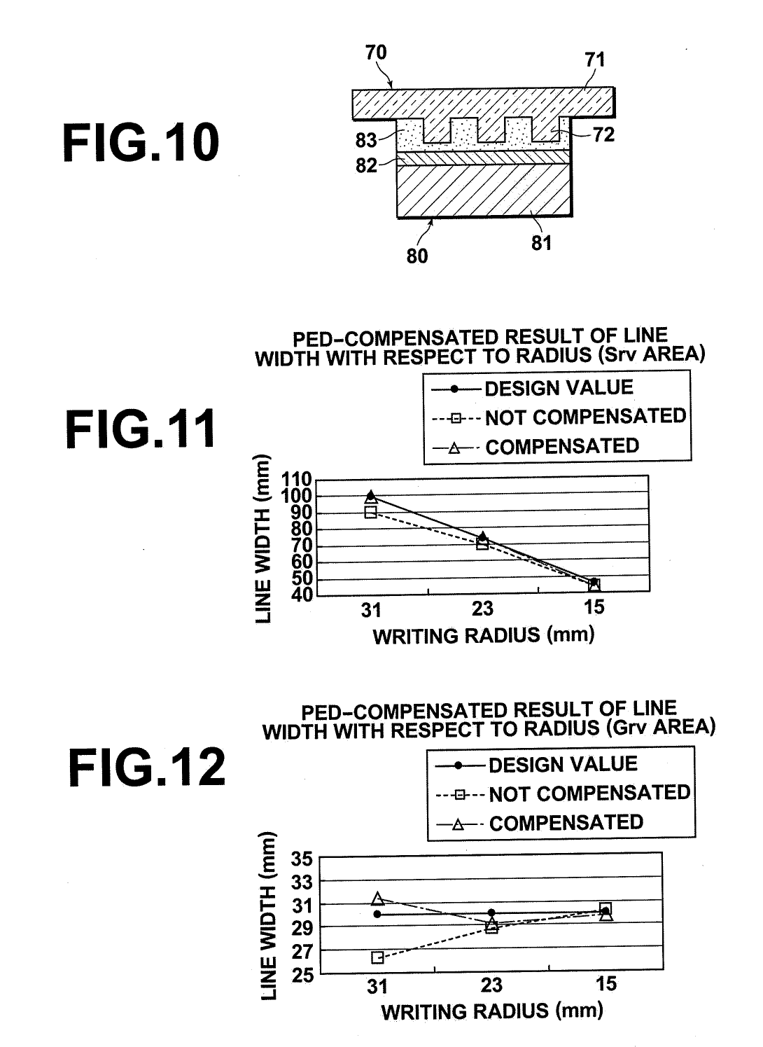

Next, a method for manufacturing an uneven pattern carrying substrate to be manufactured through a process of writing a fine pattern by the electron beam writing method described above using electron beam writing system 100 described above and a method for manufacturing a magnetic disk medium using the uneven pattern carrying substrate so manufactured will described. FIG. 10 is a schematic cross-sectional view illustrating a transfer-forming process of a fine uneven pattern using an imprint mold, which is one form of the uneven pattern carrying substrate.

Imprint mold 70 includes substrate 71 made of a transparent material on which resist 11 is coated and a fine pattern for magnetic disk medium is written thereon. Thereafter, resist 11 is processed to form an uneven pattern of the resist on substrate 71. Substrate 71 is etched with the patterned resist as the mask, and then the resist is removed, whereby imprint mold 70 having fine uneven pattern 72 formed thereon is obtained. As an example, fine uneven pattern 72 includes servo patterns and groove patterns for a discrete track medium.

Magnetic disk medium 80 is manufactured by imprint method using imprint mold 70. Magnetic disk medium 80 includes substrate 81 on which magnetic layer 82 is stacked and resist resin layer 83 for forming a mask layer is coated thereon. The uneven shape of fine uneven pattern 72 is transfer formed by pressing fine uneven pattern 72 of imprint mold 70 against resist resin layer 83 and solidifying resist resin layer 83 by ultraviolet radiation. Thereafter, magnetic layer 82 is etched based on the uneven shape of resist resin layer 83 to form magnetic disk medium 80 of discrete track medium with the fine uneven pattern formed on magnetic layer 82.

### Example

An Example of the present invention and a Comparative Example will now be described. As an Example, pattern writing was performed using a writing data signal which is based on the correction condition for compensating for resist sensitivity degradation due to PED obtained with respect to the specific example described in the embodiment of the electron beam writing method. Further, as a Comparative Example, pattern writing was performed using a writing data signal that does not include a correction for compensating for the resist sensitivity degradation due to PED.

### (Evaluation Conditions)

For the Example and Comparative Example provided through PEB, and development after pattern writing, automatic line width measurements were performed using a critical dimension SEM. The length of the inspection area (longitudinal length of lines and spaces) is set to 1 μm with an edge point detection interval of 2.5 nm within the inspection area length. Note that 100 space line widths were measured and an average value was calculated for each of the Example and Comparative Example.

FIG. 11 is a graph illustrating a design value, and line widths (IT) of Example (compensated) and Comparative Example (not compensated) in the Srv area at each writing radius. FIG. 12 is a graph illustrating a design value, and line widths (groove width) of Example (compensated) and Comparative Example (not compensated) in the Grv area at each writing radius. The graphs shown in FIGS. 11 and 12 were obtained by measuring the line widths based on the aforementioned evaluation conditions.

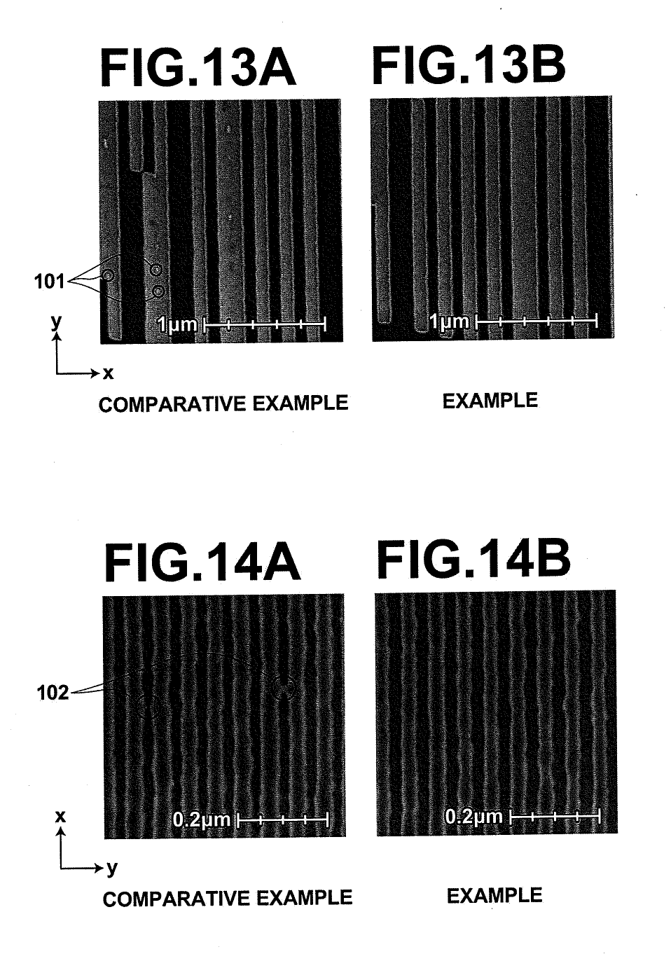

FIGS. 13A, 13B, and FIGS. 14A, 14B are SEM images of resist patterns after development. FIGS. 13A, 13B show resist patterns of preamble patterns in servo areas of the Comparative Example and Example near a writing radius of 31 mm respectively. In FIGS. 13A, 13B, the gray portions are exposed portions (space portions) exposed as the servo pattern, while black portions are non-exposed portions (line portions). In the Comparative Example shown in FIG. 13A, white residues 101 are remaining in the center of 2 T space portions. On the other hand, in the Example shown in FIG. 13B, it is clear that a favorable pattern is formed without any residues in the 2 T space portions. The 2 T space portion is written for each 1 T element and if the exposure amount is not corrected and insufficient, insufficiently exposed portions are formed between elements which may remain as residues after development, as shown in FIG. 13A. FIG. 11 shows that, in the case where the exposure amount is not corrected, thinning of line width (width in a circumferential direction) occurs in a servo area on the outer circumferential side in which post exposure delay becomes large. By implementing the exposure correction of the present invention, spaces with a line width substantially corresponding to the design value were obtained also on the outer circumferential side.

FIGS. 14A, 14B show resist patterns of groove areas of the Comparative Example and Example near a writing radius of 31 mm respectively. In FIGS. 14A, 14B, the black portions are exposed portions (space portions) exposed as the groove pattern, while gray portions are non-exposed portions (line portions). In the Comparative Example shown in FIG. 14A, bridges 102 extending between lines are formed and it is thought that the insufficiency of exposure amount (sensitivity degradation) has occurred at these points. On the other hand, no bridge is formed and lines and spaces are formed substantially in 1:1 ratio in the Example, as shown in FIG. 14B. FIG. 12 shows that, in the case where the exposure amount is not corrected, thinning of line width (width in a radial direction) is very significant in a groove area on the outer circumferential side in which post exposure delay becomes large. By implementing the exposure amount correction of the present invention, spaces with a line width closer to the design value were obtained also on the outer circumferential side in comparison with the case where the exposure amount correction is not implemented.

What is claimed is:

1. An electron beam writing method for writing a fine pattern for a disk-shaped recording medium on a substrate coated with a resist and placed on a rotation stage by applying an electron beam on the substrate while rotating the substrate by rotating the rotation stage and repeatedly changing the writing radius position of the electron beam after each round of writing, the fine pattern including servo patterns and groove patterns extending in a track direction to separate adjacent tracks,
the method comprising the step of adjusting an exposure amount of the resist by changing, when controlling application timing of the electron beam by an ON/OFF signal to a blanking unit that blocks the electron beam, an application duty ratio of the electron beam by the ON/OFF signal with respect to each writing radius position for each pattern based on sensitivity variation data of the resist with respect to post exposure delay for each pattern.

2. The electron beam writing method of claim 1, wherein the step of adjusting an exposure amount of the resist comprises the steps of:
obtaining an exposure amount to be compensated for with respect to the post exposure delay for each pattern from the sensitivity variation data of the resist with respect to post exposure delay for each pattern; and
setting the application duty ratio of the electron beam by obtaining a corrected exposure amount with respect to each writing radius for each pattern from the relationship between the writing radius and the post exposure delay.

3. The electron beam writing method of claim 1, wherein the servo pattern is written by rapidly vibrating the electron beam in circumferential directions or radial directions, as well as deflecting in a direction orthogonal to the rapidly vibrating directions, to individually scan each servo element having a shape of one track width with one bit length and constituting the servo pattern such that the shape is completely exposed by the electron beam; and
the groove pattern is written by dividing the groove pattern into a plurality of groove elements and deflecting the electron beam in a circumferential direction opposite to a direction of the rotation of the rotation stage to individually scan each groove element.

4. The electron beam writing method of claim 2, wherein the servo pattern is written by rapidly vibrating the electron beam in circumferential directions or radial directions, as well as deflecting in a direction orthogonal to the rapidly vibrating directions, to individually scan each servo element having a shape of one track width with one bit length and constituting the servo pattern such that the shape is completely exposed by the electron beam; and
the groove pattern is written by dividing the groove pattern into a plurality of groove elements and deflecting the electron beam in a circumferential direction opposite to a direction of the rotation of the rotation stage to individually scan each groove element.

5. An electron beam writing system, comprising:
an electron beam writing apparatus having a rotation stage and an electron beam application unit for scanning an electron beam on a substrate coated with a resist and placed on the rotation stage; and
a signal sending apparatus for sending a writing data signal to the electron beam writing apparatus according to a fine pattern for a disk-shaped recording medium to be written on the substrate, the fine pattern including servo patterns and groove patterns extending in a track direction to separate adjacent tracks, wherein:
the writing data signal includes a control signal for controlling application timing of the electron beam by an ON/OFF signal to a blanking unit that blocks the electron beam; and
the signal sending apparatus is an apparatus that sends, as the control signal, a control signal to the electron beam writing apparatus for adjusting an exposure amount of the resist by changing an application duty ratio of the electron beam by the ON/OFF signal with respect to each writing radius position for each pattern based on sensitivity variation data of the resist with respect to post exposure delay for each pattern.

6. A method for manufacturing an uneven pattern carrying substrate, comprising the steps of:
writing a fine pattern for a disk-shaped recording medium on a substrate coated with a resist by the electron beam writhing method of claim 1; and
using the substrate on which the fine pattern is written, forming an uneven pattern according to the fine pattern.

7. A method for manufacturing a disk-shaped recording medium, comprising the step of transferring an uneven pattern, using an imprint mold as the uneven pattern carrying substrate manufactured by the method of claim 6, according to the uneven pattern formed on a surface of the imprint mold.

8. A method for manufacturing a disk-shaped recording medium, comprising the step of transferring a magnetic pattern, using a magnetic transfer master substrate as the uneven pattern carrying substrate manufactured by the method of claim 6, according to the uneven pattern formed on a surface of the master substrate.
